(19) United States
(12) Patent Application Publication
(10) Pub. No.: US 2025/0053708 A1
(43) Pub. Date: Feb. 13, 2025

(54) METHOD FOR CALCULATING EDDY CURRENT LOSS OF TRANSFORMER, STORAGE MEDIUM AND DEVICE

(71) Applicant: Yunnan Power Grid Co., Ltd. Electric Power Research Institute, Kunming (CN)

(72) Inventors: Qingjun PENG, Kunming (CN); Xiaoxian ZHU, Kunming (CN); Dexu ZOU, Kunming (CN); Yuepei ZOU, Kunming (CN); Guochao QIAN, Kunming (CN); Fangrong ZHOU, Kunming (CN); Haozhou WANG, Kunming (CN); Shan WANG, Kunming (CN)

(73) Assignee: Yunnan Power Grid Co., Ltd. Electric Power Research Institute, (omitted)

(21) Appl. No.: 18/930,740

(22) Filed: Oct. 29, 2024

Related U.S. Application Data
(63) Continuation of application No. PCT/CN2023/095703, filed on May 23, 2023.

(30) Foreign Application Priority Data
May 17, 2023 (CN) 202310558069.5

(51) Int. Cl. G06F 30/23

(52) U.S. Cl. CPC G06F 30/23

(57) ABSTRACT

Embodiments of the present disclosure disclose a method for calculating eddy current loss of a transformer, a storage medium and a device. The calculated eddy current loss of the transformer obtained by the method is relatively accurate, and the problem that in the relevant art, a coil temperature field cloud diagram under rated capacity of the transformer is influenced by electric conductivity of an iron core, so that the calculated eddy current loss is inaccurate is solved.

### CROSS-REFERENCE TO RELATED APPLICATIONS

This application claims priority of Chinese Patent Application No. 2023105580695, filed on May 17, 2023, the contents of which is hereby incorporated by reference.

### TECHNICAL FIELD

The present disclosure relates to the technical field of power systems, in particular to a method for calculating eddy current loss of a transformer, a storage medium and a device.

### BACKGROUND

A power transformer is a main device of a power system, with its total capacity reaching 5-6 times of that of a power generation device. The technical performance and economic index of the transformer directly affect the safety, reliability and economy of the power system. A coil temperature field cloud diagram under rated capacity of the transformer is an important basis for judging the position of a hot spot of the transformer. However, in actual calculation, due to influence of electric conductivity of an iron core, calculated magnetic leakage is often large in deviation, in such a case, eddy current loss calculated according to the magnetic leakage deviates greatly from eddy current loss of rated capacity provided by a transformer manufacturer, which will enable a calculated coil temperature field cloud diagram to be inaccurate, consequently, the judgment for the position of the hot spot of the transformer is inaccurate, further, service life prediction and insulation analysis for the transformer are inaccurate, and finally, serious influence is brought to safe and stable operation of the transformer.

### SUMMARY

In view of this, it is necessary to provide a method for calculating eddy current loss of a transformer, a storage medium and a device for solving the above problem, so that the calculated eddy current loss of the transformer is relatively accurate, and the problem that in the relevant art, the coil temperature field cloud diagram under rated capacity of the transformer is influenced by electric conductivity of an iron core, so that the calculated eddy current loss is inaccurate is solved.

In order to realize the objective, in a first aspect of the present disclosure, a method for calculating eddy current loss of a transformer is provided, which includes:
acquiring basic data of a target transformer, and constructing a single-phase three-dimensional magnetic field model of the target transformer according to the basic data;
respectively calculating average magnetic leakage intensity of each coil layer in a coil of the target transformer according to the single-phase three-dimensional magnetic field model;
respectively constructing an eddy current loss weight function of each coil layer in the coil according to the average magnetic leakage intensity of each coil layer in the coil; and
respectively calculating eddy current loss of each coil layer in the coil according to a design calculation sheet of the target transformer and the eddy current loss weight function of each coil layer in the coil.

Optionally, the coil includes a high-voltage coil and a low-voltage coil, the high-voltage coil includes an A-phase high-voltage coil, a B-phase high-voltage coil and a C-phase high-voltage coil, and the low-voltage coil includes an A-phase low-voltage coil, a B-phase low-voltage coil and a C-phase low-voltage coil.
respectively calculating average magnetic leakage intensity of each coil layer in a coil of the target transformer according to the single-phase three-dimensional magnetic field model includes:
respectively calculating average magnetic leakage intensity of each coil layer in the A-phase high-voltage coil, average magnetic leakage intensity of each coil layer in the B-phase high-voltage coil and average magnetic leakage intensity of each coil layer in the C-phase high-voltage coil by the following formulas:

$${B}_{A , i , H \_ avg} = \frac{\int {B}_{A , i , H} ( {x}_{1} , {y}_{1} , {z}_{1} ) {dV}_{A , i , H}}{\int {dV}_{A , i , H}} + cos ( \frac{π}{3} ) \frac{\int {B}_{B , i , H} ( {x}_{2} , {y}_{2} , {z}_{2} ) {dV}_{B , i , H}}{\int {dV}_{B , i , H}} + cos ( \frac{2 π}{3} ) \frac{\int {B}_{C , i , H} ( {x}_{3} , {y}_{3} , {z}_{3} ) {dV}_{C , i , H}}{\int {dV}_{C , i , H}} ;$$

$${B}_{B , i , H \_ avg} = \frac{\int {B}_{B , i , H} ( {x}_{2} , {y}_{2} , {z}_{2} ) {dV}_{B , i , H}}{\int {dV}_{B , i , H}} + cos ( \frac{π}{3} ) \frac{\int {B}_{C , i , H} ( {x}_{3} , {y}_{3} , {z}_{3} ) {dV}_{C , i , H}}{\int {dV}_{C , i , H}} + cos ( \frac{2 π}{3} ) \frac{\int {B}_{A , i , H} ( {x}_{1} , {y}_{1} , {z}_{1} ) {dV}_{A , i , H}}{\int {dV}_{A , i , H}} ;$$

$${B}_{C , i , H \_ avg} = \frac{\int {B}_{C , i , H} ( {x}_{3} , {y}_{3} , {z}_{3} ) {dV}_{C , i , H}}{\int {dV}_{C , i , H}} + cos ( \frac{π}{3} ) \frac{\int {B}_{A , i , H} ( {x}_{1} , {y}_{1} , {z}_{1} ) {dV}_{A , i , H}}{\int {dV}_{A , i , H}} + cos ( \frac{2 π}{3} ) \frac{\int {B}_{B , i , H} ( {x}_{2} , {y}_{2} , {z}_{2} ) {dV}_{B , i , H}}{\int {dV}_{B , i , H}} ;$$

respectively calculating average magnetic leakage intensity of each coil layer in the A-phase low-voltage coil, average magnetic leakage intensity of each coil layer in the B-phase low-voltage coil and average magnetic leakage intensity of each coil layer in the C-phase low-voltage coil by the following formulas:

$${B}_{A , j , L \_ avg} = \frac{\int {B}_{A , j , L} ( {x}_{4} , {y}_{4} , {z}_{4} ) {dV}_{A , j , L}}{\int {dV}_{A , j , L}} + cos ( \frac{π}{3} ) \frac{\int {B}_{B , j , L} ( {x}_{5} , {y}_{5} , {z}_{5} ) {dV}_{B , j , L}}{\int {dV}_{B , j , L}} + cos ( \frac{2 π}{3} ) \frac{\int {B}_{C , j , L} ( {x}_{6} , {y}_{6} , {z}_{6} ) {dV}_{C , j , L}}{\int {dV}_{C , j , L}} ;$$

$${B}_{B , j , L \_ avg} = \frac{\int {B}_{B , j , L} ( {x}_{5} , {y}_{5} , {z}_{5} ) {dV}_{B , j , L}}{\int {dV}_{B , j , L}} + cos ( \frac{π}{3} ) \frac{\int {B}_{C , j , L} ( {x}_{6} , {y}_{6} , {z}_{6} ) {dV}_{C , j , L}}{\int {dV}_{C , j , L}} + cos ( \frac{2 π}{3} ) \frac{\int {B}_{A , j , L} ( {x}_{4} , {y}_{4} , {z}_{4} ) {dV}_{A , j , L}}{\int {dV}_{A , j , L}} ;$$

$${B}_{C , j , L \_ avg} = \frac{\int {B}_{C , j , L} ( {x}_{6} , {y}_{6} , {z}_{6} ) {dV}_{C , j , L}}{\int {dV}_{C , j , L}} + cos ( \frac{π}{3} ) \frac{\int {B}_{A , j , L} ( {x}_{4} , {y}_{4} , {z}_{4} ) {dV}_{A , j , L}}{\int {dV}_{A , j , L}} + cos ( \frac{2 π}{3} ) \frac{\int {B}_{B , j , L} ( {x}_{5} , {y}_{5} , {z}_{5} ) {dV}_{B , j , L}}{\int {dV}_{B , j , L}} ;$$

B_{A,i,H_avg} is the average magnetic leakage intensity of the ith coil layer in the A-phase high-voltage coil, B_{A,i,H}(x₁,y₁,z₁) is magnetic leakage intensity of a coordinate point (x₁,y₁,z₁) of the ith coil layer in the A-phase high-voltage coil in the single-phase three-dimensional magnetic field model, dV_{A,i,H} is a micro-volume element of the ith coil layer in the A-phase high-voltage coil, B_{B,i,H}(x₂,y₂,z₂) is magnetic leakage intensity of a coordinate point (x₂,y₂,z₂) of the ith coil layer in the B-phase high-voltage coil in the single-phase three-dimensional magnetic field model, dV_{B,i,H} is a micro-volume element of the ith coil layer in the B-phase high-voltage coil, B_{C,i,H}(x₃,y₃,z₃) is magnetic leakage intensity of a coordinate point (x₃,y₃z₃) of the ith coil layer in the C-phase high-voltage coil in the single-phase three-dimensional magnetic field model, dV_{C,i,H} is a micro-volume element of the ith coil layer in the C-phase high-voltage coil, B_{B,i,H_avg} is the average magnetic leakage intensity of the ith coil layer in the B-phase high-voltage coil, B_{C,i,H_avg} is the average magnetic leakage intensity of the ith coil layer in the C-phase high-voltage coil, B_{A,j,L_avg} is the average magnetic leakage intensity of the jth coil layer in the A-phase low-voltage coil, B_{A,j,L}(x₄,y₄,z₄) is magnetic leakage intensity of a coordinate point (x₄,y₄,z₄) of the jth coil layer in the A-phase low-voltage coil in the single-phase three-dimensional magnetic field model, dV_{A,j,L} is a micro-volume element of the jth coil layer in the A-phase low-voltage coil, B_{B,j,L}(x₅,y₅,z₅) is magnetic leakage intensity of a coordinate point (x₅,y₅,z₅) of the jth coil layer in the B-phase low-voltage coil in the single-phase three-dimensional magnetic field model, dV_{B,j,L} is a micro-volume element of the jth coil layer in the B-phase low-voltage coil, B_{C,j,L}(x₆,y₆,z₆) is magnetic leakage intensity of a coordinate point (x₆,y₆,z₆) of the jth coil layer in the C-phase low-voltage coil in the single-phase three-dimensional magnetic field model, dV_{C,j,L} is a micro-volume element of the jth coil layer in the C-phase low-voltage coil, B_{B,j,L_avg} is the average magnetic leakage intensity of the jth coil layer in the B-phase low-voltage coil, and B_{C,j,L_avg} is the average magnetic leakage intensity of the jth coil layer in the C-phase low-voltage coil.

Optionally, respectively constructing an eddy current loss weight function of each coil layer in the coil according to the average magnetic leakage intensity of each coil layer in the coil includes:
respectively constructing an eddy current loss weight function of each coil layer in the A-phase high-voltage coil, an eddy current loss weight function of each coil layer in the B-phase high-voltage coil and an eddy current loss weight function of each coil layer in the C-phase high-voltage coil by the following formulas:

$${W}_{A , i , H} = \frac{{B}_{A , i , H \_ avg}^{2}}{{\sum }_{i = 1}^{n} {B}_{A , i , H \_ avg}^{2}} , {W}_{B , i , H} = \frac{{B}_{B , i , H \_ avg}^{2}}{{\sum }_{i = 1}^{n} {B}_{B , i , H \_ avg}^{2}} , {W}_{C , i , H} = \frac{{B}_{C , i , H \_ avg}^{2}}{{\sum }_{i = 1}^{n} {B}_{C , i , H \_ avg}^{2}} ;$$

respectively constructing an eddy current loss weight function of each coil layer in the A-phase low-voltage coil, an eddy current loss weight function of each coil layer in the B-phase low-voltage coil and an eddy current loss weight function of each coil layer in the C-phase low-voltage coil by the following formulas:

$${W}_{A , j , L} = \frac{{B}_{A , j , L \_ avg}^{2}}{{\sum }_{j = 1}^{m} {B}_{A , j , L \_ avg}^{2}} , {W}_{B , j , L} = \frac{{B}_{B , j , L \_ avg}^{2}}{{\sum }_{j = 1}^{m} {B}_{B , j , L \_ avg}^{2}} , {W}_{C , j , L} = \frac{{B}_{C , j , L \_ avg}^{2}}{{\sum }_{j = 1}^{m} {B}_{C , j , L \_ avg}^{2}} ;$$

W_{A,i,H} is the eddy current loss weight function of the ith coil layer in the A-phase high-voltage coil, n is the total number of the coil layer of the A-phase high-voltage coil, the B-phase high-voltage coil or the C-phase high-voltage coil, W_{B,i,H} is the eddy current loss weight function of the ith coil layer in the B-phase high-voltage coil, W_{C,i,H} is the eddy current loss weight function of the ith coil layer in the C-phase high-voltage coil, W_{A,j,L} is the eddy current loss weight function of the jth coil layer in the A-phase low-voltage coil, m is the total number of the coil layer of the A-phase low-voltage coil, the B-phase low-voltage coil or the C-phase low-voltage coil, W_{B,j,L} is the eddy current loss weight function of the jth coil layer in the B-phase low-voltage coil, and W_{C,j,L} is the eddy current loss weight function of the jth coil layer in the C-phase low-voltage coil.

Optionally, respectively calculating eddy current loss of each coil layer in the coil according to a design calculation sheet of the target transformer and the eddy current loss weight function of each coil layer in the coil includes:
respectively calculating eddy current loss of each coil layer in the A-phase high-voltage coil, eddy current loss of each coil layer in the B-phase high-voltage coil and eddy current loss of each coil layer in the C-phase high-voltage coil by the following formulas:

$${W}_{A , i , H \_ ecl} = \frac{{W}_{A , i , H} \times {W}_{H \_ list}}{3} , \\ {W}_{B , i , H \_ ecl} = \frac{{W}_{B , i , H} \times {W}_{H \_ list}}{3} , {W}_{C , i , H \_ ecl} = \frac{{W}_{C , i , H} \times {W}_{H \_ list}}{3} ;$$

respectively calculating eddy current loss of each coil layer in the A-phase low-voltage coil, eddy current loss of each coil layer in the B-phase low-voltage coil and eddy current loss of each coil layer in the C-phase low-voltage coil by the following formulas:

$${W}_{A , j , L \_ ecl} = \frac{{W}_{A , j , L} \times {W}_{L \_ list}}{3} , \\ {W}_{B , j , L \_ ecl} = \frac{{W}_{B , j , L} \times {W}_{L \_ list}}{3} , {W}_{C , j , L \_ ecl} = \frac{{W}_{C , j , L} \times {W}_{L \_ list}}{3} ;$$

W_{A,i,H_ecl} is the eddy current loss of the ith coil layer in the A-phase high-voltage coil, W_{H_list} is eddy current loss under high voltage, on the design calculation sheet, of the target transformer, W_{B,i,H_ecl} is the eddy current loss of the ith coil layer in the B-phase high-voltage coil, W_{C,i,H_ecl} is the eddy current loss of the ith coil layer in the C-phase high-voltage coil, W_{A,j,L_ecl} is the eddy current loss of the jth coil layer in the A-phase low-voltage coil, W_{L_list} is eddy current loss under low voltage, on the design calculation sheet, of the target transformer, W_{B,j,L_ecl} is the eddy current loss of the jth coil layer in the B-phase low-voltage coil, and W_{C,j,L_ecl} is the eddy current loss of the jth coil layer in the C-phase low-voltage coil.

Optionally, the method further includes:
judging whether the coil further includes a medium-voltage coil or not, and the medium-voltage coil includes an A-phase medium-voltage coil, a B-phase medium-voltage coil and a C-phase medium-voltage coil;
in the case that the coil further includes the medium-voltage coil, respectively calculating average magnetic leakage intensity of each coil layer in a coil of the target transformer according to the single-phase three-dimensional magnetic field model further includes:
respectively calculating average magnetic leakage intensity of each coil layer in the A-phase medium-voltage coil, average magnetic leakage intensity of each coil layer in the B-phase medium-voltage coil and average magnetic leakage intensity of each coil layer in the C-phase medium-voltage coil by the following formulas:

$${B}_{A , k , M \_ avg} = \frac{\int {B}_{A , k , M} ( {x}_{7} , {y}_{7} , {z}_{7} ) {dV}_{A , k , M}}{\int {dV}_{A , k , M}} + cos ( \frac{π}{3} ) \frac{\int {B}_{B , k , M} ( {x}_{8} , {y}_{8} , {z}_{8} ) {dV}_{B , k , M}}{\int {dV}_{B , k , M}} + cos ( \frac{2 π}{3} ) \frac{\int {B}_{C , k , M} ( {x}_{9} , {y}_{9} , {z}_{9} ) {dV}_{C , k , M}}{\int {dV}_{C , k , M}} ;$$

$${B}_{B , k , M \_ avg} = \frac{\int {B}_{B , k , M} ( {x}_{8} , {y}_{8} , {z}_{8} ) {dV}_{B , k , M}}{\int {dV}_{B , k , M}} + cos ( \frac{π}{3} ) \frac{\int {B}_{C , k , M} ( {x}_{9} , {y}_{9} , {z}_{9} ) {dV}_{C , k , M}}{\int {dV}_{C , k , M}} + cos ( \frac{2 π}{3} ) \frac{\int {B}_{A , k , M} ( {x}_{7} , {y}_{7} , {z}_{7} ) {dV}_{A , k , M}}{\int {dV}_{A , k , M}} ;$$

$${B}_{C , k , M \_ avg} = \frac{\int {B}_{C , k , M} ( {x}_{9} , {y}_{9} , {z}_{9} ) {dV}_{C , k , M}}{\int {dV}_{C , k , M}} + cos ( \frac{π}{3} ) \frac{\int {B}_{A , k , M} ( {x}_{7} , {y}_{7} , {z}_{7} ) {dV}_{A , k , M}}{\int {dV}_{A , k , M}} + cos ( \frac{2 π}{3} ) \frac{\int {B}_{B , k , M} ( {x}_{8} , {y}_{8} , {z}_{8} ) {dV}_{B , k , M}}{\int {dV}_{B , k , M}} ;$$

B_{A,k,M_avg} is the average magnetic leakage intensity of the kth coil layer in the A-phase medium-voltage coil, B_{A,k,M}(x₇,y₇,z₇) is magnetic leakage intensity of a coordinate point (x₇,y₇,z₇) of the kth coil layer in the A-phase medium-voltage coil in the single-phase three-dimensional magnetic field model, dV_{A,k,M} is a micro-volume element of the kth coil layer in the A-phase medium-voltage coil, B_{B,k,M}(x₈,y₈,z₈) is magnetic leakage intensity of a coordinate point (x₈,y₈,z₈) of the kth coil layer in the B-phase medium-voltage coil in the single-phase three-dimensional magnetic field model, dV_{B,k,M} is a micro-volume element of the kth coil layer in the B-phase medium-voltage coil, B_{C,k,M}(x₉,y₉,z₉) is magnetic leakage intensity of a coordinate point (x₉,y₉,z₉) of the kth coil layer in the C-phase medium-voltage coil in the single-phase three-dimensional magnetic field model, dV_{C,k,M} is a micro-volume element of the kth coil layer in the C-phase medium-voltage coil, B_{B,k,M_avg} is the average magnetic leakage intensity of the kth coil layer in the B-phase medium-voltage coil, and B_{C,k,M_avg} is the average magnetic leakage intensity of the kth coil layer in the C-phase medium-voltage coil.

Optionally, respectively constructing an eddy current loss weight function of each coil layer in the coil according to the average magnetic leakage intensity of each coil layer in the coil further includes:
respectively constructing an eddy current loss weight function of each coil layer in the A-phase medium-voltage coil, an eddy current loss weight function of each coil layer in the B-phase medium-voltage coil and an eddy current loss weight function of each coil layer in the C-phase medium-voltage coil by the following formulas:

$${W}_{A , k , M} = \frac{{B}_{A , k , M \_ avg}^{2}}{{\sum }_{k = 1}^{p} {B}_{A , k , M \_ avg}^{2}} , {W}_{B , k , M} = \frac{{B}_{B , k , M \_ avg}^{2}}{{\sum }_{k = 1}^{p} {B}_{B , k , M \_ avg}^{2}} , {W}_{C , k , M} = \frac{{B}_{C , k , M \_ avg}^{2}}{{\sum }_{k = 1}^{p} {B}_{C , k , M \_ avg}^{2}} ;$$

W_{A,k,M} is the eddy current loss weight function of the kth coil layer in the A-phase medium-voltage coil, p is the total number of the coil layer of the A-phase medium-voltage coil, the B-phase medium-voltage coil or the C-phase medium-voltage coil, W_{B,k,M} is the eddy current loss weight function of the kth coil layer in the B-phase medium-voltage coil, and W_{C,k,M} is the eddy current loss weight function of the kth coil layer in the C-phase medium-voltage coil.

Optionally, respectively calculating eddy current loss of each coil layer in the coil according to a design calculation sheet of the target transformer and the eddy current loss weight function of each coil layer in the coil further includes:
respectively calculating eddy current loss of each coil layer in the A-phase medium-voltage coil, eddy current loss of each coil layer in the B-phase medium-voltage coil and eddy current loss of each coil layer in the C-phase medium-voltage coil by the following formulas:

$${W}_{A , k , M \_ ecl} = \frac{{W}_{A , k , M} \times {W}_{M \_ list}}{3} , {W}_{B , k , M \_ ecl} = \frac{{W}_{B , k , M} \times {W}_{M \_ list}}{3} , {W}_{C , k , M \_ ecl} = \frac{{W}_{C , k , M} \times {W}_{M \_ list}}{3} ;$$

W_{A,k,M_ecl} is the eddy current loss of the kth coil layer in the A-phase medium-voltage coil, W_{M_list} is eddy current loss under medium voltage, on the design calculation sheet, of the target transformer, W_{B,k,M_ecl} is the eddy current loss of the kth coil layer in the B-phase medium-voltage coil, and W_{C,k,M_ecl} is the eddy current loss of the kth coil layer in the C-phase medium-voltage coil.

Optionally, the basic data includes structural data of an iron core of the target transformer, structural data of the coil, structural data of a box, and rated current of the target transformer.

In order to realize the objective, in a second aspect of the present disclosure, an apparatus for calculating eddy current loss of a transformer is provided, which includes:
an acquiring and constructing module, which is configured for acquiring basic data of a target transformer, and constructing a single-phase three-dimensional magnetic field model of the target transformer according to the basic data;
a magnetic leakage calculating module, which is configured for respectively calculating average magnetic leakage intensity of each coil layer in a coil of the target transformer according to the single-phase three-dimensional magnetic field model;
a weight function constructing module, which is configured for respectively constructing an eddy current loss weight function of each coil layer in the coil according to the average magnetic leakage intensity of each coil layer in the coil; and
an eddy current loss calculating module, which is configured for respectively calculating eddy current loss of each coil layer in the coil according to a design calculation sheet of the target transformer and the eddy current loss weight function of each coil layer in the coil.

In order to realize the objective, in a third aspect of the present disclosure, a computer-readable storage medium is provided, having stored thereon a computer program, and when the computer program is executed by a processor, the processor implements the method of any one of the first aspect.

In order to realize the objective, in a fourth aspect of the present disclosure, a computer device is provided, which includes a memory and a processor. The memory stores a computer program. When the computer program is implemented by the processor, the processor implements the method of any one of the first aspect.

By adoption of the embodiment of the present disclosure, the following beneficial effects are obtained: in the above method, by acquiring basic data of the target transformer, constructing the single-phase three-dimensional magnetic field model of the target transformer according to the basic data, then respectively calculating the average magnetic leakage intensity of each coil layer in the coil of the target transformer according to the single-phase three-dimensional magnetic field model, respectively constructing the eddy current loss weight function of each coil layer in the coil according to the average magnetic leakage intensity of each coil layer in the coil, and finally, respectively calculating the eddy current loss of each coil layer in the coil according to the design calculation sheet of the target transformer and the eddy current loss weight function of each coil layer in the coil, distribution of the eddy current loss of the target transformer in space (that is, distribution in a three-dimensional coordinate system of the single-phase three-dimensional magnetic field model) is obtained. Eddy current loss calculated by adopting the method of the transformer is relatively accurate, so that the problem that in the relevant art, the coil temperature field cloud diagram under rated capacity of the transformer is influenced by electric conductivity of an iron core, so that the calculated eddy current loss is inaccurate is solved. In addition, the method calculates the eddy current loss of the transformer by constructing the single-phase three-dimensional magnetic field model, so the distribution of the eddy current loss of the transformer in space may be obtained, the coil temperature field cloud diagram may be calculated, and then the position of the hot spot of the transformer may be quickly and accurately judged.

### BRIEF DESCRIPTION OF DRAWINGS

In order to describe the technical solutions in the embodiments of the present disclosure or in the relevant art more clearly, the drawings that need to be used in the description of the embodiments or the relevant art will be briefly introduced below. Apparently, the drawings in the description below are merely some embodiments of the present disclosure, and those of ordinary skill in the art may also acquire other drawings according to these drawings without creative efforts.

In the drawings:

FIG. 1 is a schematic diagram of a method for calculating eddy current loss of a transformer in an embodiment of the present disclosure;

FIG. 2 is a schematic diagram of a single-phase three-dimensional magnetic field model of A phase constructed in an embodiment of the present disclosure;

FIG. 3 is a schematic diagram of a coil layer in a coil in an embodiment of the present disclosure;

FIG. 4 is a schematic diagram of an apparatus for calculating eddy current loss of a transformer in an embodiment of the present disclosure; and

FIG. 5 is an internal structure diagram of a computer device in some embodiments.

### DETAILED DESCRIPTION OF THE EMBODIMENTS

The technical solutions in the embodiments of the present disclosure will be described clearly and completely below in combination with the drawings in the embodiments of the present disclosure. Apparently, the described embodiments are merely a part, rather than all embodiments, of the present disclosure. On the basis of the embodiments in the present disclosure, all other embodiments acquired by those of ordinary skill in the art without creative efforts fall within the protection scope of the present disclosure.

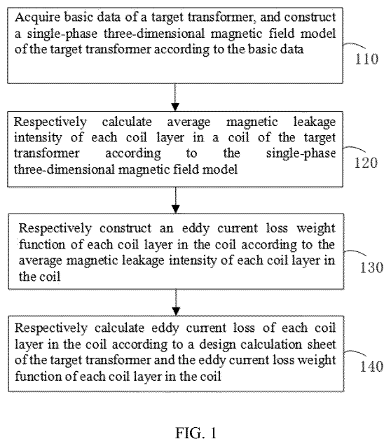

FIG. 1 is a schematic diagram of a method for calculating eddy current loss of a transformer in an embodiment of the present disclosure. The method includes the following steps.

S110: basic data of a target transformer is acquired, and a single-phase three-dimensional magnetic field model of the target transformer is constructed according to the basic data.

The target transformer is a transformer selected for calculating eddy current loss in the present disclosure, and the basic data includes but is not limited to structural data of an iron core of the target transformer, structural data of a coil, structural data of a box, and rated current corresponding to rated capacity of the target transformer. It can be understood that the present disclosure needs to construct a single-phase three-dimensional magnetic field model corresponding to the target transformer in order to calculate magnetic leakage of the target transformer, and therefore, the single-phase three-dimensional magnetic field model needs to be constructed according to data including the structural data of the iron core of the target transformer, the structural data of the coil, the structural data of the box, and the rated current corresponding to the rated capacity of the target transformer.

It is to be noted that as finite element may simulate various structures of complicated geometric shapes and may accurately predict real physical parameters, in some embodiments, the single-phase three-dimensional magnetic field model of the present disclosure adopts a finite element model to construct the single-phase three-dimensional magnetic field model corresponding to the target transformer to the maximum extent.

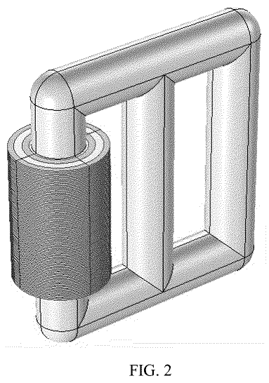

It is to be further noted that the single-phase three-dimensional magnetic field model constructed in the present disclosure may be a single-phase three-dimensional magnetic field model of any of A phase, B phase and C phase, for example, FIG. 2 is a schematic diagram of a single-phase three-dimensional magnetic field model of A phase constructed in an embodiment of the present disclosure, in which a constructed single-phase three-dimensional magnetic field model of A phase is illustrated (that is, for ease of explanation, it is assumed that any phase is the A phase, and A phase is used as an example); and in addition, the single-phase three-dimensional magnetic field model constructed in the present disclosure may also be three single-phase three-dimensional magnetic field models of corresponding three phases including A phase, B phase and C phase.

It can be understood that no matter the single-phase three-dimensional magnetic field model constructed in the present disclosure is a single-phase three-dimensional magnetic field model of any of A phase, B phase and C phase, or three single-phase three-dimensional magnetic field models of corresponding three phases including A phase, B phase and C phase, the technical solution in the embodiment of the present disclosure may be realized, and therefore, preferably, the present disclosure only constructs the single-phase three-dimensional magnetic field model of any phase (such as the single-phase three-dimensional magnetic field model of A phase).

S120: average magnetic leakage intensity of each coil layer in a coil of the target transformer is respectively calculated according to the single-phase three-dimensional magnetic field model.

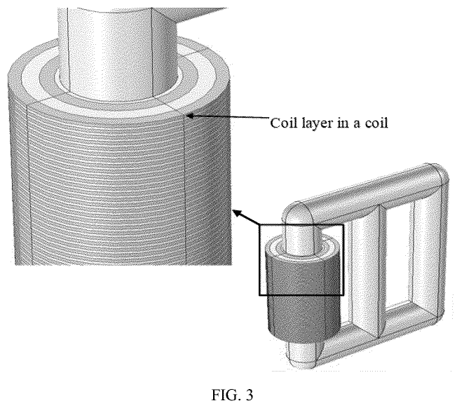

It is to be noted that when the single-phase three-dimensional magnetic field model is constructed, the used structure of the coil of the target transformer is fine to a coil layer structure, therefore, in the present disclosure, the calculated average magnetic leakage intensity is accurate to each coil layer in the coil of the target transformer, for example, FIG. 3 is a schematic diagram of a coil layer in a coil in an embodiment of the present disclosure, in which the coil layer in the coil of the single-phase three-dimensional magnetic field model of the A phase of the present disclosure is illustrated. It can be understood the calculated average magnetic leakage intensity accurate to each coil layer in the coil is relatively precise and relatively accurate relative to the method for calculating magnetic leakage intensity in the relevant art.

In some embodiments, if the single-phase three-dimensional magnetic field model constructed in the present disclosure is a single-phase three-dimensional magnetic field model of A phase, the average magnetic leakage intensity of each coil layer in the A-phase coil of the target transformer may be respectively calculated according to the single-phase three-dimensional magnetic field model of A phase, then according to the position of the average magnetic leakage intensity of each coil layer in the A-phase coil in the single-phase three-dimensional magnetic field model of A phase, the average magnetic leakage intensity of each coil layer in the B-phase coil of the target transformer at the corresponding position in the single-phase three-dimensional magnetic field model of A phase is respectively calculated according to a symmetry principle and a magnetic field superposition principle, and the average magnetic leakage intensity of each coil layer in the C-phase coil of the target transformer at the corresponding position in the single-phase three-dimensional magnetic field model of A phase is respectively calculated; and similarly, if the single-phase three-dimensional magnetic field model constructed by the present disclosure is a single-phase three-dimensional magnetic field model of B phase or C phase, the average magnetic leakage intensity of each coil layer in the coils of the remaining two phases may also be calculated by adopting the method in the embodiment.

In other embodiments, if the single-phase three-dimensional magnetic field model constructed in the present disclosure is three single-phase three-dimensional magnetic field models of corresponding three phases including A phase, B phase and C phase, the average magnetic leakage intensity of each coil layer in the A-phase coil of the target transformer may be respectively calculated according to the single-phase three-dimensional magnetic field model of A phase, the average magnetic leakage intensity of each coil layer in the B-phase coil of the target transformer may be respectively calculated according to the single-phase three-dimensional magnetic field model of B phase, and the average magnetic leakage intensity of each coil layer in the C-phase coil of the target transformer may be respectively calculated according to the single-phase three-dimensional magnetic field model of C phase.

S130: an eddy current loss weight function of each coil layer in the coil is respectively constructed according to the average magnetic leakage intensity of each coil layer in the coil.

In some embodiments, after the average magnetic leakage intensity of each coil layer in the A-phase coil, the average magnetic leakage intensity of each coil layer in the B-phase coil and the average magnetic leakage intensity of each coil layer in the C-phase coil are obtained, the eddy current loss weight function of each coil layer in the A-phase coil may be respectively constructed according to the average magnetic leakage intensity of each coil layer in the A-phase coil, the eddy current loss weight function of each coil layer in the B-phase coil may be respectively constructed according to the average magnetic leakage intensity of each coil layer in the B-phase coil, and the eddy current loss weight function of each coil layer in the C-phase coil may be respectively constructed according to the average magnetic leakage intensity of each coil layer in the C-phase coil.

S140: eddy current loss of each coil layer in the coil is respectively calculated according to a design calculation sheet of the target transformer and the eddy current loss weight function of each coil layer in the coil.

It is to be noted that the design calculation sheet is provided by a manufacturer of the target transformer, it can be understood that the manufacturer of the transformer have corresponding design calculation sheets for all produced transformers, in which various loss values are listed in detail, and the present disclosure needs to use eddy current loss in the design calculation sheet for calculating eddy current loss of each coil layer in the coil.

In some embodiments, after the eddy current loss weight function of each coil layer in the A-phase coil, the eddy current loss weight function of each coil layer in the B-phase coil and the eddy current loss weight function of each coil layer in the C-phase coil are obtained, eddy current loss of each coil layer in the A-phase coil may be respectively calculated according to eddy current loss in the design calculation sheet and the eddy current loss weight function of each coil layer in the A-phase coil, eddy current loss of each coil layer in the B-phase coil may be respectively calculated according to eddy current loss in the design calculation sheet and the eddy current loss weight function of each coil layer in the B-phase coil, and eddy current loss of each coil layer in the C-phase coil may be respectively calculated according to eddy current loss in the design calculation sheet and the eddy current loss weight function of each coil layer in the C-phase coil.

In addition, it is to be noted that as the target transformer of the present disclosure is a three-phase transformer, the coil of the target transformer has three phases including A phase, B phase, and C phase (that is, corresponding to international three phases including U phase, V phase, and W phase), and the calculated eddy current loss also has three phases including A phase, B phase, and C phase, of course, if the target transformer is a single-phase transformer, the embodiment of the present disclosure may be adopted for calculating eddy current loss.

In the embodiment of the present disclosure, by acquiring the basic data of the target transformer, constructing the single-phase three-dimensional magnetic field model of the target transformer according to the basic data, then respectively calculating the average magnetic leakage intensity of each coil layer in the coil of the target transformer according to the single-phase three-dimensional magnetic field model, respectively constructing the eddy current loss weight function of each coil layer in the coil according to the average magnetic leakage intensity of each coil layer in the coil, and finally, respectively calculating the eddy current loss of each coil layer in the coil according to the design calculation sheet of the target transformer and the eddy current loss weight function of each coil layer in the coil, distribution of the eddy current loss of the target transformer in space (that is, distribution in a three-dimensional coordinate system of the single-phase three-dimensional magnetic field model) is obtained. The eddy current loss calculated by adopting the method of the transformer is relatively accurate, so that the problem that in the relevant art, the coil temperature field cloud diagram under rated capacity of the transformer is influenced by electric conductivity of an iron core, so that the calculated eddy current loss is inaccurate is solved. In addition, the method calculates the eddy current loss of the transformer by constructing the single-phase three-dimensional magnetic field model, so that the distribution of the eddy current loss of the transformer in space may be obtained, the coil temperature field cloud diagram may be calculated, and then the position of the hot spot of the transformer may be quickly and accurately judged.

In a feasible implementation mode, the coil in the above embodiment includes a high-voltage coil and a low-voltage coil.

The high-voltage coil includes an A-phase high-voltage coil, a B-phase high-voltage coil and a C-phase high-voltage coil, and the low-voltage coil includes an A-phase low-voltage coil, a B-phase low-voltage coil and a C-phase low-voltage coil.

It is to be noted that the type of the coil is related to the target transformer. In the case that the target transformer has only a high-voltage coil and a low-voltage coil, the coil in the above embodiment includes the high-voltage coil and the low-voltage coil; and in the case that the target transformer has only a high-voltage coil, a medium-voltage coil and a low-voltage coil, the coil in the above embodiments includes the high-voltage coil, the medium-voltage coil and the low-voltage coil.

In the case that the coil includes the high-voltage coil and the low-voltage coil, S120: average magnetic leakage intensity of each coil layer in a coil of the target transformer is respectively calculated according to the single-phase three-dimensional magnetic field model in the above embodiment includes:
average magnetic leakage intensity of each coil layer in the A-phase high-voltage coil, average magnetic leakage intensity of each coil layer in the B-phase high-voltage coil and average magnetic leakage intensity of each coil layer in the C-phase high-voltage coil are respectively calculated by the following formulas:

$${B}_{A , i , H \_ avg} = \frac{\int {B}_{A , i , H} ( {x}_{1} , {y}_{1} , {z}_{1} ) {dV}_{A , i , H}}{\int {dV}_{A , i , H}} + cos ( \frac{π}{3} ) \frac{\int {B}_{B , i , H} ( {x}_{2} , {y}_{2} , {z}_{2} ) {dV}_{B , i , H}}{\int {dV}_{B , i , H}} + cos ( \frac{2 π}{3} ) \frac{\int {B}_{C , i , H} ( {x}_{3} , {y}_{3} , {z}_{3} ) {dV}_{C , i , H}}{\int {dV}_{C , i , H}} ;$$

$${B}_{B , i , H \_ avg} = \frac{\int {B}_{B , i , H} ( {x}_{2} , {y}_{2} , {z}_{2} ) {dV}_{B , i , H}}{\int {dV}_{B , i , H}} + cos ( \frac{π}{3} ) \frac{\int {B}_{C , i , H} ( {x}_{3} , {y}_{3} , {z}_{3} ) {dV}_{C , i , H}}{\int {dV}_{C , i , H}} + cos ( \frac{2 π}{3} ) \frac{\int {B}_{A , i , H} ( {x}_{1} , {y}_{1} , {z}_{1} ) {dV}_{A , i , H}}{\int {dV}_{A , i , H}} ;$$

$${B}_{C , i , H \_ avg} = \frac{\int {B}_{C , i , H} ( {x}_{3} , {y}_{3} , {z}_{3} ) {dV}_{C , i , H}}{\int {dV}_{C , i , H}} + cos ( \frac{π}{3} ) \frac{\int {B}_{A , i , H} ( {x}_{1} , {y}_{1} , {z}_{1} ) {dV}_{A , i , H}}{\int {dV}_{A , i , H}} + cos ( \frac{2 π}{3} ) \frac{\int {B}_{B , i , H} ( {x}_{2} , {y}_{2} , {z}_{2} ) {dV}_{B , i , H}}{\int {dV}_{B , i , H}} ;$$

average magnetic leakage intensity of each coil layer in the A-phase low-voltage coil, average magnetic leakage intensity of each coil layer in the B-phase low-voltage coil and average magnetic leakage intensity of each coil layer in the C-phase low-voltage coil are respectively calculated by the following formulas:

$${B}_{A , j , L \_ avg} = \frac{\int {B}_{A , j , L} ( {x}_{4} , {y}_{4} , {z}_{4} ) {dV}_{A , j , L}}{\int {dV}_{A , j , L}} + cos ( \frac{π}{3} ) \frac{\int {B}_{B , j , L} ( {x}_{5} , {y}_{5} , {z}_{5} ) {dV}_{B , j , L}}{\int {dV}_{B , j , L}} + cos ( \frac{2 π}{3} ) \frac{\int {B}_{C , j , L} ( {x}_{6} , {y}_{6} , {z}_{6} ) {dV}_{C , j , L}}{\int {dV}_{C , j , L}} ;$$

$${B}_{B , j , L \_ avg} = \frac{\int {B}_{B , j , L} ( {x}_{5} , {y}_{5} , {z}_{5} ) {dV}_{B , j , L}}{\int {dV}_{B , j , L}} + cos ( \frac{π}{3} ) \frac{\int {B}_{C , j , L} ( {x}_{6} , {y}_{6} , {z}_{6} ) {dV}_{C , j , L}}{\int {dV}_{C , j , L}} + cos ( \frac{2 π}{3} ) \frac{\int {B}_{A , j , L} ( {x}_{4} , {y}_{4} , {z}_{4} ) {dV}_{A , j , L}}{\int {dV}_{A , j , L}} ;$$

$${B}_{C , j , L \_ avg} = \frac{\int {B}_{C , j , L} ( {x}_{6} , {y}_{6} , {z}_{6} ) {dV}_{C , j , L}}{\int {dV}_{C , j , L}} + cos ( \frac{π}{3} ) \frac{\int {B}_{A , j , L} ( {x}_{4} , {y}_{4} , {z}_{4} ) {dV}_{A , j , L}}{\int {dV}_{A , j , L}} + cos ( \frac{2 π}{3} ) \frac{\int {B}_{B , j , L} ( {x}_{5} , {y}_{5} , {z}_{5} ) {dV}_{B , j , L}}{\int {dV}_{B , j , L}} ;$$

B_{A,i,H_avg} is the average magnetic leakage intensity of the ith coil layer in the A-phase high-voltage coil, B_{A,i,H}(x₁,y₁,z₁) is the magnetic leakage intensity of a coordinate point (x₁,y₁,z₁) of the ith coil layer in the A-phase high-voltage coil in the single-phase three-dimensional magnetic field model, dV_{A,i,H} is a micro-volume element of the ith coil layer in the A-phase high-voltage coil, B_{B,i,H}(x₂,y₂,z₂) is magnetic leakage intensity of a coordinate point (x₂,y₂,z₂) of the ith coil layer in the B-phase high-voltage coil in the single-phase three-dimensional magnetic field model, dV_{B,i,H} is a micro-volume element of the ith coil layer in the B-phase high-voltage coil, B_{C,i,H}(x₃,y₃,z₃) is the magnetic leakage intensity of a coordinate point (x₃,y₃,z₃) of the ith coil layer in the C-phase high-voltage coil in the single-phase three-dimensional magnetic field model, dV_{C,i,H} is a micro-volume element of the ith coil layer in the C-phase high-voltage coil, B_{B,i,H_avg} is the average magnetic leakage intensity of the ith coil layer in the B-phase high-voltage coil, B_{C,i,H_avg} is the average magnetic leakage intensity of the ith coil layer in the C-phase high-voltage coil, B_{A,j,L_avg} is the average magnetic leakage intensity of the jth coil layer in the A-phase low-voltage coil, B_{A,j,L}(x₄,y₄,z₄) is the magnetic leakage intensity of a coordinate point (x₄,y₄,z₄) of the jth coil layer in the A-phase low-voltage coil in the single-phase three-dimensional magnetic field model, dV_{A,j,L} is a micro-volume element of the jth coil layer in the A-phase low-voltage coil, B_{B,j,L}(x₅,y₅,z₅) is magnetic leakage intensity of a coordinate point (x₅,y₅,z₅) of the jth coil layer in the B-phase low-voltage coil in the single-phase three-dimensional magnetic field model, dV_{B,j,L} is a micro-volume element of the jth coil layer in the B-phase low-voltage coil, B_{C,j,L}(x₆,y₆,z₆) is the magnetic leakage intensity of a coordinate point (x₆,y₆,z₆) of the jth coil layer in the C-phase low-voltage coil in the single-phase three-dimensional magnetic field model, dV_{C,j,L} is a micro-volume element of the jth coil layer in the C-phase low-voltage coil, B_{B,j,L_avg} is the average magnetic leakage intensity of the jth coil layer in the B-phase low-voltage coil, and B_{C,j,L_avg} is the average magnetic leakage intensity of the jth coil layer in the C-phase low-voltage coil.

In the embodiment of the present disclosure, strict formulas for calculating the average magnetic leakage intensity of each coil layer in the A-phase high-voltage coil, the average magnetic leakage intensity of each coil layer in the B-phase high-voltage coil, the average magnetic leakage intensity of each coil layer in the C-phase high-voltage coil, the average magnetic leakage intensity of each coil layer in the A-phase low-voltage coil, the average magnetic leakage intensity of each coil layer in the B-phase low-voltage coil and the average magnetic leakage intensity of each coil layer in the C-phase low-voltage coil are provided through mathematics, the accuracy of the calculated average magnetic leakage intensity may be ensured from rigor of mathematical logic, meanwhile, by preferably illustrating formulas for calculating the average magnetic leakage intensity of each coil layer in the A-phase high-voltage coil, the average magnetic leakage intensity of each coil layer in the B-phase high-voltage coil, the average magnetic leakage intensity of each coil layer in the C-phase high-voltage coil, the average magnetic leakage intensity of each coil layer in the A-phase low-voltage coil, the average magnetic leakage intensity of each coil layer in the B-phase low-voltage coil and the average magnetic leakage intensity of each coil layer in the C-phase low-voltage coil, reference, understanding, calculating and the like may be provided for technicians. In addition, by performing micro-volume element accurate to each coordinate point of each coil layer in the coil, the accuracy of the calculated average magnetic leakage intensity may be ensured, so that relatively accurate average magnetic leakage intensity may be obtained, meanwhile, when the average magnetic leakage intensity calculated through the mode is used for calculating eddy current loss, distribution of the eddy current loss of the transformer in space may be obtained, so that the coil temperature field cloud diagram may be calculated, and then the position of the hot spot of the transformer may be quickly and accurately judged.

In a feasible implementation mode, in the case that the coil includes the high-voltage coil and the low-voltage coil, S130: an eddy current loss weight function of each coil layer in the coil is respectively constructed according to the average magnetic leakage intensity of each coil layer in the coil in the above embodiment includes:
an eddy current loss weight function of each coil layer in the A-phase high-voltage coil, an eddy current loss weight function of each coil layer in the B-phase high-voltage coil and an eddy current loss weight function of each coil layer in the C-phase high-voltage coil are respectively constructed by the following formulas:

$${W}_{A , i , H} = \frac{{B}_{A , i , H \_ avg}^{2}}{{\sum }_{i = 1}^{n} {B}_{A , i , H \_ avg}^{2}} , {W}_{B , i , H} = \frac{{B}_{B , i , H \_ avg}^{2}}{{\sum }_{i = 1}^{n} {B}_{B , i , H \_ avg}^{2}} , {W}_{C , i , H} = \frac{{B}_{C , i , H \_ avg}^{2}}{{\sum }_{i = 1}^{n} {B}_{C , i , H \_ avg}^{2}} ;$$

an eddy current loss weight function of each coil layer in the A-phase low-voltage coil, an eddy current loss weight function of each coil layer in the B-phase low-voltage coil and an eddy current loss weight function of each coil layer in the C-phase low-voltage coil are respectively constructed by the following formulas:

$${W}_{A , j , L} = \frac{{B}_{A , j , L \_ avg}^{2}}{{\sum }_{j = 1}^{m} {B}_{A , j , L \_ avg}^{2}} , {W}_{B , j , L} = \frac{{B}_{B , j , L \_ avg}^{2}}{{\sum }_{j = 1}^{m} {B}_{B , j , L \_ avg}^{2}} , {W}_{C , j , L} = \frac{{B}_{C , j , L \_ avg}^{2}}{{\sum }_{j = 1}^{m} {B}_{C , j , L \_ avg}^{2}} ;$$

W_{A,i,H} is the eddy current loss weight function of the ith coil layer in the A-phase high-voltage coil, n is the total number of the coil layer of the A-phase high-voltage coil, the B-phase high-voltage coil or the C-phase high-voltage coil, W_{B,i,H} is the eddy current loss weight function of the ith coil layer in the B-phase high-voltage coil, W_{C,i,H} is the eddy current loss weight function of the ith coil layer in the C-phase high-voltage coil, W_{A,j,L} is the eddy current loss weight function of the jth coil layer in the A-phase low-voltage coil, m is the total number of the coil layer of the A-phase low-voltage coil, the B-phase low-voltage coil or the C-phase low-voltage coil, W_{B,j,L} is the eddy current loss weight function of the jth coil layer in the B-phase low-voltage coil, and W_{C,j,L} is the eddy current loss weight function of the jth coil layer in the C-phase low-voltage coil.

In the embodiment of the present disclosure, strict formulas for constructing the eddy current loss weight function of each coil layer in the A-phase high-voltage coil, the eddy current loss weight function of each coil layer in the B-phase high-voltage coil, the eddy current loss weight function of each coil layer in the C-phase high-voltage coil, the eddy current loss weight function of each coil layer in the A-phase low-voltage coil, the eddy current loss weight function of each coil layer in the B-phase low-voltage coil and the eddy current loss weight function of each coil layer in the C-phase low-voltage coil are provided through mathematics, the accuracy of the constructed eddy current loss weight function may be ensured from rigor of mathematical logic, and meanwhile, by preferably illustrating formulas for constructing the eddy current loss weight function of each coil layer in the A-phase high-voltage coil, the eddy current loss weight function of each coil layer in the B-phase high-voltage coil, the eddy current loss weight function of each coil layer in the C-phase high-voltage coil, the eddy current loss weight function of each coil layer in the A-phase low-voltage coil, the eddy current loss weight function of each coil layer in the B-phase low-voltage coil and the eddy current loss weight function of each coil layer in the C-phase low-voltage coil, reference, understanding, constructing and the like may be provided for technicians. In addition, when calculating eddy current loss by adopting the eddy current loss weight function constructed through the mode, distribution of the eddy current loss of the transformer in space may be obtained, so that the coil temperature field cloud diagram may be calculated, and then the position of the hot spot of the transformer may be quickly and accurately judged.

In a feasible implementation mode, under the condition that the coil includes the high-voltage coil and the low-voltage coil, S140: eddy current loss of each coil layer in the coil is respectively calculated according to a design calculation sheet of the target transformer and the eddy current loss weight function of each coil layer in the coil in the above embodiment includes:
eddy current loss of each coil layer in the A-phase high-voltage coil, eddy current loss of each coil layer in the B-phase high-voltage coil and eddy current loss of each coil layer in the C-phase high-voltage coil are respectively calculated by the following formulas:

$${W}_{A , i , H \_ ecl} = \frac{{W}_{A , i , H} \times {W}_{H \_ list}}{3} , \\ {W}_{B , i , H \_ ecl} = \frac{{W}_{B , i , H} \times {W}_{H \_ list}}{3} , {W}_{C , i , H \_ ecl} = \frac{{W}_{C , i , H} \times {W}_{H \_ list}}{3} ;$$

eddy current loss of each coil layer in the A-phase low-voltage coil, eddy current loss of each coil layer in the B-phase low-voltage coil and eddy current loss of each coil layer in the C-phase low-voltage coil are respectively calculated by the following formulas:

$${W}_{A , j , L \_ ecl} = \frac{{W}_{A , j , L} \times {W}_{L \_ list}}{3} , \\ {W}_{B , j , L \_ ecl} = \frac{{W}_{B , j , L} \times {W}_{L \_ list}}{3} , {W}_{C , j , L \_ ecl} = \frac{{W}_{C , j , L} \times {W}_{L \_ list}}{3} ;$$

W_{A,i,H_ecl} is the eddy current loss of the ith coil layer in the A-phase high-voltage coil, W_{H_list} is the eddy current loss under high voltage, on the design calculation sheet, of the target transformer, W_{B,i,H_ecl} is the eddy current loss of the ith coil layer in the B-phase high-voltage coil, W_{C,i,H_ecl} is the eddy current loss of the ith coil layer in the C-phase high-voltage coil, W_{A,j,L_ecl} is the eddy current loss of the jth coil layer in the A-phase low-voltage coil, W_{L_list} is eddy current loss under low voltage, on the design calculation sheet, of the target transformer, W_{B,j,L_ecl} is the eddy current loss of the jth coil layer in the B-phase low-voltage coil, and W_{C,j,L_ecl} is the eddy current loss of the jth coil layer in the C-phase low-voltage coil.

In the embodiment of the present disclosure, strict formulas for constructing the eddy current loss of each coil layer in the A-phase high-voltage coil, the eddy current loss of each coil layer in the B-phase high-voltage coil, the eddy current loss of each coil layer in the C-phase high-voltage coil, the eddy current loss of each coil layer in the A-phase low-voltage coil, the eddy current loss of each coil layer in the B-phase low-voltage coil and the eddy current loss of each coil layer in the C-phase low-voltage coil are provided through mathematics, the accuracy of the calculated eddy current loss may be ensured from rigor of mathematical logic, and meanwhile, by preferably illustrating formulas for calculating the eddy current loss of each coil layer in the A-phase high-voltage coil, the eddy current loss of each coil layer in the B-phase high-voltage coil, the eddy current loss of each coil layer in the C-phase high-voltage coil, the eddy current loss of each coil layer in the A-phase low-voltage coil, the eddy current loss of each coil layer in the B-phase low-voltage coil and the eddy current loss of each coil layer in the C-phase low-voltage coil, reference, understanding, calculating and the like may be provided for technicians. In addition, through the eddy current loss calculated through the mode, distribution of the eddy current loss of the transformer in space may be obtained, so that the coil temperature field cloud diagram may be calculated, and then the position of the hot spot of the transformer may be quickly and accurately judged.

In a feasible implementation mode, the method in the above embodiment further includes: whether the coil further includes a medium-voltage coil or not is judged.

The medium-voltage coil includes an A-phase medium-voltage coil, a B-phase medium-voltage coil and a C-phase medium-voltage coil.

It is to be noted that there is a case that the target transformer has the high-voltage coil and the low-voltage coil and a case that the target transformer has the high-voltage coil, the medium-voltage coil and the low-voltage coil, therefore, under the condition that the coil includes the high-voltage coil and the low-voltage coil in the above embodiment, whether the coil in the above embodiment further includes the medium-voltage coil or not needs to be judged.

In the case that the coil further includes the medium-voltage coil, S120: average magnetic leakage intensity of each coil layer in a coil of the target transformer is respectively calculated according to the single-phase three-dimensional magnetic field model further includes:
average magnetic leakage intensity of each coil layer in the A-phase medium-voltage coil, average magnetic leakage intensity of each coil layer in the B-phase medium-voltage coil and average magnetic leakage intensity of each coil layer in the C-phase medium-voltage coil are respectively calculated by the following formulas:

$${B}_{A , k , M \_ avg} = \frac{\int {B}_{A , k , M} ( {x}_{7} , {y}_{7} , {z}_{7} ) {dV}_{A , k , M}}{\int {dV}_{A , k , M}} + cos ( \frac{π}{3} ) \frac{\int {B}_{B , k , M} ( {x}_{8} , {y}_{8} , {z}_{8} ) {dV}_{B , k , M}}{\int {dV}_{B , k , M}} + cos ( \frac{2 π}{3} ) \frac{\int {B}_{C , k , M} ( {x}_{9} , {y}_{9} , {z}_{9} ) {dV}_{C , k , M}}{\int {dV}_{C , k , M}} ;$$

$${B}_{B , k , M \_ avg} = \frac{\int {B}_{B , k , M} ( {x}_{8} , {y}_{8} , {z}_{8} ) {dV}_{B , k , M}}{\int {dV}_{B , k , M}} + cos ( \frac{π}{3} ) \frac{\int {B}_{C , k , M} ( {x}_{9} , {y}_{9} , {z}_{9} ) {dV}_{C , k , M}}{\int {dV}_{C , k , M}} + cos ( \frac{2 π}{3} ) \frac{\int {B}_{A , k , M} ( {x}_{7} , {y}_{7} , {z}_{7} ) {dV}_{A , k , M}}{\int {dV}_{A , k , M}} ;$$

$${B}_{C , k , M \_ avg} = \frac{\int {B}_{C , k , M} ( {x}_{9} , {y}_{9} , {z}_{9} ) {dV}_{C , k , M}}{\int {dV}_{C , k , M}} + cos ( \frac{π}{3} ) \frac{\int {B}_{A , k , M} ( {x}_{7} , {y}_{7} , {z}_{7} ) {dV}_{A , k , M}}{\int {dV}_{A , k , M}} + cos ( \frac{2 π}{3} ) \frac{\int {B}_{B , k , M} ( {x}_{8} , {y}_{8} , {z}_{8} ) {dV}_{B , k , M}}{\int {dV}_{B , k , M}} ;$$

B_{A,k,M_avg} is the average magnetic leakage intensity of the kth coil layer in the A-phase medium-voltage coil, B_{A,k,m}(x₇,y₇,z₇) is magnetic leakage intensity of a coordinate point (x₇,y₇,z₇) of the kth coil layer in the A-phase medium-voltage coil in the single-phase three-dimensional magnetic field model, dV_{A,k,M} is a micro-volume element of the kth coil layer in the A-phase medium-voltage coil, B_{B,k,M}(x₈,y₈,z₈) is magnetic leakage intensity of a coordinate point (x₈,y₈,z₈) of the kth coil layer in the B-phase medium-voltage coil in the single-phase three-dimensional magnetic field model, dV_{B,k,M} is a micro-volume element of the kth coil layer in the B-phase medium-voltage coil, B_{C,k,M}(x₉,y₉,z₉) is magnetic leakage intensity of a coordinate point (x₉,y₉,z₉) of the kth coil layer in the C-phase medium-voltage coil in the single-phase three-dimensional magnetic field model, dV_{C,k,M} is a micro-volume element of the kth coil layer in the C-phase medium-voltage coil, B_{B,k,M_avg} is the average magnetic leakage intensity of the kth coil layer in the B-phase medium-voltage coil, and B_{C,k,M_avg} is the average magnetic leakage intensity of the kth coil layer in the C-phase medium-voltage coil.

In the embodiment of the present disclosure, strict formulas for calculating the average magnetic leakage intensity of each coil layer in the A-phase medium-voltage coil, the average magnetic leakage intensity of each coil layer in the B-phase medium-voltage coil, and the average magnetic leakage intensity of each coil layer in the C-phase medium-voltage coil are provided through mathematics, the accuracy of the calculated average magnetic leakage intensity may be ensured from rigor of mathematical logic, and meanwhile, by preferably illustrating formulas for calculating the average magnetic leakage intensity of each coil layer in the A-phase medium-voltage coil, the average magnetic leakage intensity of each coil layer in the B-phase medium-voltage coil, and the average magnetic leakage intensity of each coil layer in the C-phase medium-voltage coil, reference, understanding, calculating and the like may be provided for technicians. In addition, by performing micro-volume element accurate to each coordinate point of each coil layer in the coil, the accuracy of the calculated average magnetic leakage intensity may be ensured, so that relatively accurate average magnetic leakage intensity may be obtained, meanwhile, when the average magnetic leakage intensity calculated through the mode is used for calculating the eddy current loss, distribution of the eddy current loss of the transformer in space may be obtained, so that the coil temperature field cloud diagram may be calculated, and then the position of the hot spot of the transformer may be quickly and accurately judged.

In a feasible implementation mode, under the condition that the coil further includes the medium-voltage coil, S130: an eddy current loss weight function of each coil layer in the coil is respectively constructed according to the average magnetic leakage intensity of each coil layer in the coil in the above embodiment further includes:
an eddy current loss weight function of each coil layer in the A-phase medium-voltage coil, an eddy current loss weight function of each coil layer in the B-phase medium-voltage coil and an eddy current loss weight function of each coil layer in the C-phase medium-voltage coil are respectively constructed by the following formulas:

$${W}_{A , k , M} = \frac{{B}_{A , k , M \_ avg}^{2}}{{\sum }_{k = 1}^{P} {B}_{A , k , M \_ avg}^{2}} , {W}_{B , k , M} = \frac{{B}_{B , k , M \_ avg}^{2}}{{\sum }_{k = 1}^{P} {B}_{B , k , M \_ avg}^{2}} , {W}_{C , k , M} = \frac{{B}_{C , k , M \_ avg}^{2}}{{\sum }_{k = 1}^{P} {B}_{C , k , M \_ avg}^{2}}$$

W_{A,k,M} is the eddy current loss weight function of the kth coil layer in the A-phase medium-voltage coil, p is the total number of the coil layer of the A-phase medium-voltage coil, the B-phase medium-voltage coil or the C-phase medium-voltage coil, W_{B,k,M} is the eddy current loss weight function of the kth coil layer in the B-phase medium-voltage coil, and W_{C,k,M} is the eddy current loss weight function of the kth coil layer in the C-phase medium-voltage coil.

In the embodiment of the present disclosure, strict formulas for constructing the eddy current loss weight function of each coil layer in the A-phase medium-voltage coil, the eddy current loss weight function of each coil layer in the B-phase medium-voltage coil and the eddy current loss weight function of each coil layer in the C-phase medium-voltage coil are provided through mathematics, the accuracy of the constructed eddy current loss weight function may be ensured from rigor of mathematical logic, and meanwhile, by preferably illustrating formulas for constructing the eddy current loss weight function of each coil layer in the A-phase medium-voltage coil, the eddy current loss weight function of each coil layer in the B-phase medium-voltage coil, and the eddy current loss weight function of each coil layer in the C-phase medium-voltage coil, reference, understanding, constructing and the like may be provided for technicians. In addition, when calculating the eddy current loss by adopting the eddy current loss weight function constructed through the mode, distribution of the eddy current loss of the transformer in space may be obtained, so that the coil temperature field cloud diagram may be calculated, and then the position of the hot spot of the transformer may be quickly and accurately judged.

In a feasible implementation mode, under the condition that the coil further includes the medium-voltage coil, S140: eddy current loss of each coil layer in the coil is respectively calculated according to a design calculation sheet of the target transformer and the eddy current loss weight function of each coil layer in the coil in the above embodiment further includes:
eddy current loss of each coil layer in the A-phase medium-voltage coil, eddy current loss of each coil layer in the B-phase medium-voltage coil and eddy current loss of each coil layer in the C-phase medium-voltage coil are respectively calculated by the following formulas:

$${W}_{A , k , M \_ ecl} = \frac{{W}_{A , k , M} \times {W}_{M \_ list}}{3} , \\ {W}_{B , k , M \_ ecl} = \frac{{W}_{B , k , M} \times {W}_{M \_ list}}{3} , {W}_{C , k , M \_ ecl} = \frac{{W}_{C , k , M} \times {W}_{M \_ list}}{3}$$

W_{A,k,M_ecl} is the eddy current loss of the kth coil layer in the A-phase medium-voltage coil, W_{M-list} is eddy current loss under medium voltage, on the design calculation sheet, of the target transformer, W_{B,k,M_ecl} is the eddy current loss of the kth coil layer in the B-phase medium-voltage coil, and W_{C,k,M_ecl} is the eddy current loss of the kth coil layer in the C-phase medium-voltage coil.

In the embodiment of the present disclosure, strict formulas for calculating the eddy current loss of each coil layer in the A-phase medium-voltage coil, the eddy current loss of each coil layer in the B-phase medium-voltage coil and the eddy current loss of each coil layer in the C-phase medium-voltage coil are provided through mathematics, the accuracy of the calculated eddy current loss may be ensured from rigor of mathematical logic, and meanwhile, by preferably illustrating formulas for calculating the eddy current loss of each coil layer in the A-phase medium-voltage coil, the eddy current loss of each coil layer in the B-phase medium-voltage coil, and the eddy current loss of each coil layer in the C-phase medium-voltage coil, reference, understanding, calculating and the like may be provided for technicians. In addition, through the eddy current loss calculated through the mode, distribution of the eddy current loss of the transformer in space may be obtained, so that the coil temperature field cloud diagram may be calculated, and then the position of the hot spot of the transformer may be quickly and accurately judged.

In a feasible implementation mode, in S110 of the above embodiment, the basic data includes structural data of an iron core of the target transformer, structural data of the coil, structural data of a box, and rated current of the target transformer.

In some embodiments, the structural data of the iron core includes but is not limited to the length, width and height of a core column, the length, width and height of an iron yoke, the material (such as silicon steel sheet material) of the iron core, the electromagnetic parameters (such as electric conductivity, B-H curve, namely, magnetization curve, B-P curve, namely, input and output curve) of the iron core, and thermal parameters (such as density, thermal conductivity and specific heat capacity) of the iron core; the structural data of the coil includes but is not limited to the number of turns of the coil, the connection mode of the coil, the inner and outer diameters and height of each winding of the coil, the material (such as copper material) of the winding of the coil, the electromagnetic parameters (such as electric conductivity and relative magnetic permeability) of the winding of the coil, and thermal parameters (such as density, thermal conductivity and specific heat capacity) of the winding of the coil; and the structural data of the box includes but is not limited to the length, width and height of the box, the material (such as iron) of the box, the electromagnetic parameters (such as electric conductivity and relative magnetic permeability) of the box, and thermal parameters (such as density, thermal conductivity and specific heat capacity) of the box.

In other embodiments, in order to enable the single-phase three-dimensional magnetic field model constructed by adopting the basic data to be more accurate, the basic data may further include the size of an insulator (such as an insulation cylinder, an angle ring, a pad and a stay), electromagnetic parameters (such as electric conductivity and relative magnetic permeability) of the insulator, thermal parameters (such as density, thermal conductivity and specific heat capacity) of the insulator, electromagnetic parameters (such as electric conductivity and relative magnetic permeability) of transformer oil, fluid parameters (all parameters need to consider temperature correlation, such as density, viscosity, thermal conductivity and specific heat capacity) of the transformer oil, load current amplitude of each winding of the coil, flow rate of transformer oil, cold source temperature of transformer oil, ambient temperature, surface convection heat transfer coefficient of the box, surface emissivity of a material, and the like.

It is to be noted that when an operator constructs the single-phase three-dimensional magnetic field model, various parameter information of the above example may be correspondingly increased or decreased according to actual needs of the operator. It can be understood that the operator may correspondingly increase or decrease various parameters included in the basic data of the target transformer according to the accuracy requirements for the constructed single-phase three-dimensional magnetic field model, so as to meet the requirements of the constructed single-phase three-dimensional magnetic field model.

In the embodiment of the present disclosure, by preferably illustrating various parameters included in the basic data of the target transformer, a basis may be provided for a technician to construct the single-phase three-dimensional magnetic field model of the target transformer, so that the technician may construct the single-phase three-dimensional magnetic field model corresponding to the target transformer according to various parameters included in the basic data provided by the present disclosure, so as to obtain distribution of the eddy current loss of the transformer in space, then the coil temperature field cloud diagram may be calculated, and the position of the hot spot of the transformer may be quickly and accurately judged.

In some embodiments, the present disclosure further provides an apparatus for calculating eddy current loss of a transformer.

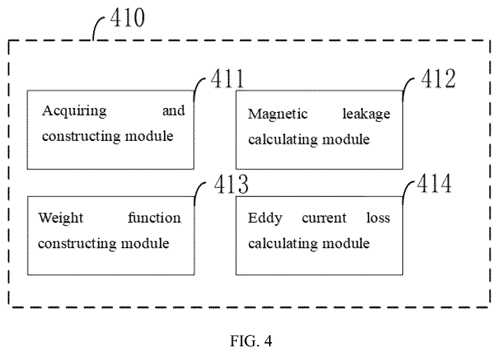

FIG. 4 is a schematic diagram of an apparatus for calculating eddy current loss of a transformer in an embodiment of the present disclosure, and the apparatus 410 includes:
an acquiring and constructing module 411, which is configured for acquiring basic data of a target transformer, and constructing a single-phase three-dimensional magnetic field model of the target transformer according to the basic data;
a magnetic leakage calculating module 412, which is configured for respectively calculating average magnetic leakage intensity of each coil layer in a coil of the target transformer according to the single-phase three-dimensional magnetic field model;
a weight function constructing module 413, which is configured for respectively constructing an eddy current loss weight function of each coil layer in the coil according to the average magnetic leakage intensity of each coil layer in the coil; and
an eddy current loss calculating module 414, which is configured for respectively calculating eddy current loss of each coil layer in the coil according to a design calculation sheet of the target transformer and the eddy current loss weight function of each coil layer in the coil.

In the embodiment of the present disclosure, the relevant contents of the above acquiring and constructing module 411, magnetic leakage calculating module 412, weight function constructing module 413 and eddy current loss calculating module 414 may refer to contents in the embodiment shown in FIG. 1, and no elaboration will be made here.

It is to be noted that the apparatus 410 of the present disclosure further includes other modules, it can be understood that the method of the present disclosure is in one-to-one correspondence with the apparatus 410, and therefore, the other modules of the apparatus 410 of the present disclosure are the corresponding content of the method of the present disclosure in the above embodiment.

In the embodiment of the present disclosure, by acquiring basic data of the target transformer, constructing the single-phase three-dimensional magnetic field model of the target transformer according to the basic data, then respectively calculating the average magnetic leakage intensity of each coil layer in the coil of the target transformer according to the single-phase three-dimensional magnetic field model, respectively constructing the eddy current loss weight function of each coil layer in the coil according to the average magnetic leakage intensity of each coil layer in the coil, and finally, respectively calculating the eddy current loss of each coil layer in the coil according to the design calculation sheet of the target transformer and the eddy current loss weight function of each coil layer in the coil, distribution of the eddy current loss of the target transformer in space (that is, distribution in a three-dimensional coordinate system of the single-phase three-dimensional magnetic field model) is obtained. The eddy current loss calculated by adopting the apparatus 410 is relatively accurate, so that the problem that in the relevant art, the coil temperature field cloud diagram under rated capacity of the transformer is influenced by electric conductivity of the iron core, so that the calculated eddy current loss is inaccurate is solved. In addition, the apparatus 410 calculates the eddy current loss of the transformer by constructing the single-phase three-dimensional magnetic field model, so that the distribution of the eddy current loss of the transformer in space may be obtained, the coil temperature field cloud diagram may be calculated, and then the position of the hot spot of the transformer may be quickly and accurately judged.

In some embodiments, the present disclosure further provides a computer-readable storage medium, having stored thereon a computer program, and when the computer program is executed by a processor, the processor implements the method for calculating eddy current loss of a transformer in the above method embodiment.

In some embodiments, the present disclosure further provides a computer device, which includes a memory and a processor. The memory stores a computer program. When the computer program is implemented by the processor, the processor implements the method for calculating eddy current loss of a transformer in the above method embodiment.

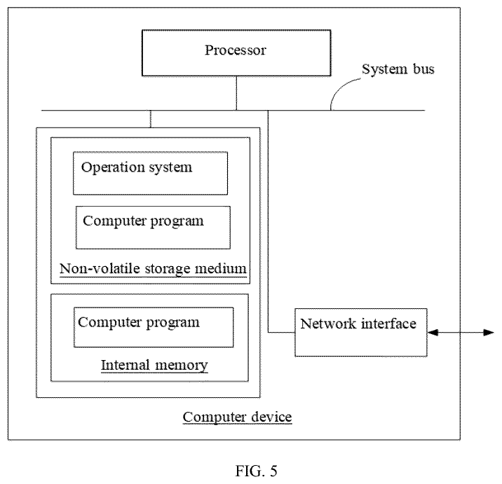

FIG. 5 illustrates an internal structure diagram of a computer device in some embodiments. The computer device may be a terminal, a server, or a gateway. As shown in FIG. 5, the computer device includes a processor, a memory and a network interface which are connected through a system bus.

The memory includes a non-volatile storage medium and an internal memory. The non-volatile storage medium of the computer device stores an operation system and may also store a computer program. When the computer program is implemented by the processor, the processor implements the steps in the above method embodiment. The internal memory may also store a computer program, and when the computer program is executed by the processor, the processor implements the steps in the above method embodiment. The skilled in the art may understand that the structure shown in FIG. 5 is only a block diagram of a part of structure relevant to the solution of the present disclosure, but does not limit the computer device to which the solution of the present disclosure is applied, and the specific computer device may include more or fewer components than shown in the figure, or a combination of certain components, or different component arrangements.

Those of ordinary skill in the art may understand that all or part of the process for implementing the method of the above embodiments may be completed by instructing relevant hardware through the computer program, the program may be stored in a non-volatile computer-readable storage medium, and when the program is executed, the process of the embodiment of each method above may be included.

Any reference to the memory, the storage, the database, or other medium used in the various embodiments provided in the present disclosure may include a non-volatile and/or volatile memory. The nonvolatile memory may include a Read Only Memory (ROM), a Programmable ROM (PROM), an Electrically Programmable ROM (EPROM), an Electrically Erasable Programmable ROM (EEPROM), or a flash memory. The volatile memory may include a Random Access Memory (RAM) or an external cache memory. By way of illustration and not limitation, the RAM is available in many forms such as a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), a Rambus Direct RAM (RDRAM), a Direct Rambus Dynamic RAM (DRDRAM), and a Rambus Dynamic RAM (RDRAM).

The technical features of the above embodiments can be randomly combined, and not all possible combinations of the technical features in the above-described embodiments are described for simplicity of description, however, as long as the combinations of the technical features do not contradict each other, they should be considered to be within the scope of the description of the present specification.

The embodiments described above represent only several implementation modes of the present disclosure, and the description is specific and detailed, but should not be construed as limiting the scope of present disclosure accordingly. It should be pointed out that those of ordinary skill in the art can also make several changes and improvements without departing from the concept of the present disclosure, and these changes and improvements all fall within the scope of protection of the present disclosure. Therefore, the protection scope of the present disclosure shall be subject to the appended claims.

What is claimed is:

1. A method for calculating eddy current loss of a transformer, comprising:
acquiring basic data of a target transformer, and constructing a single-phase three-dimensional magnetic field model of the target transformer according to the basic data;
respectively calculating average magnetic leakage intensity of each coil layer in a coil of the target transformer according to the single-phase three-dimensional magnetic field model;
respectively constructing an eddy current loss weight function of each coil layer in the coil according to the average magnetic leakage intensity of each coil layer in the coil; and
respectively calculating eddy current loss of each coil layer in the coil according to a design calculation sheet of the target transformer and the eddy current loss weight function of each coil layer in the coil.

2. The method according to claim 1, wherein the coil comprises a high-voltage coil and a low-voltage coil, the high-voltage coil comprises an A-phase high-voltage coil, a B-phase high-voltage coil and a C-phase high-voltage coil, and the low-voltage coil comprises an A-phase low-voltage coil, a B-phase low-voltage coil and a C-phase low-voltage coil;
the respectively calculating average magnetic leakage intensity of each coil layer in a coil of the target transformer according to the single-phase three-dimensional magnetic field model comprises:
respectively calculating average magnetic leakage intensity of each coil layer in the A-phase high-voltage coil, average magnetic leakage intensity of each coil layer in the B-phase high-voltage coil and average magnetic leakage intensity of each coil layer in the C-phase high-voltage coil by the following formulas:
$${B}_{A , i , H \_ avg} = \frac{\int {B}_{A , i , H} ( {x}_{1} , {y}_{1} , {z}_{1} ) {dV}_{A , i , H}}{\int {dV}_{A , i , H}} + cos ( \frac{π}{3} ) \frac{\int {B}_{B , i , H} ( {x}_{2} , {y}_{2} , {z}_{2} ) {dV}_{B , i , H}}{\int {dV}_{B , i , H}} + cos ( \frac{2 π}{3} ) \frac{\int {B}_{C , i , H} ( {x}_{3} , {y}_{3} , {z}_{3} ) {dV}_{C , i , H}}{\int {dV}_{C , i , H}} ;$$
$${B}_{B , i , H \_ avg} = \frac{\int {B}_{B , i , H} ( {x}_{2} , {y}_{2} , {z}_{2} ) {dV}_{B , i , H}}{\int {dV}_{B , i , H}} + cos ( \frac{π}{3} ) \frac{\int {B}_{C , i , H} ( {x}_{3} , {y}_{3} , {z}_{3} ) {dV}_{C , i , H}}{\int {dV}_{C , i , H}} + cos ( \frac{2 π}{3} ) \frac{\int {B}_{A , i , H} ( {x}_{1} , {y}_{1} , {z}_{1} ) {dV}_{A , i , H}}{\int {dV}_{A , i , H}} ;$$
$${B}_{C , i , H \_ avg} = \frac{\int {B}_{C , i , H} ( {x}_{3} , {y}_{3} , {z}_{3} ) {dV}_{C , i , H}}{\int {dV}_{C , i , H}} + cos ( \frac{π}{3} ) \frac{\int {B}_{A , i , H} ( {x}_{1} , {y}_{1} , {z}_{1} ) {dV}_{A , i , H}}{\int {dV}_{A , i , H}} + cos ( \frac{2 π}{3} ) \frac{\int {B}_{B , i , H} ( {x}_{2} , {y}_{2} , {z}_{2} ) {dV}_{B , i , H}}{\int {dV}_{B , i , H}} ;$$
respectively calculating average magnetic leakage intensity of each coil layer in the A-phase low-voltage coil, average magnetic leakage intensity of each coil layer in the B-phase low-voltage coil and average magnetic leakage intensity of each coil layer in the C-phase low-voltage coil by the following formulas:
$${B}_{A , j , L \_ avg} = \frac{\int {B}_{A , j , L} ( {x}_{4} , {y}_{4} , {z}_{4} ) {dV}_{A , j , L}}{\int {dV}_{A , j , L}} + cos ( \frac{π}{3} ) \frac{\int {B}_{B , j , L} ( {x}_{5} , {y}_{5} , {z}_{5} ) {dV}_{B , j , L}}{\int {dV}_{B , j , L}} + cos ( \frac{2 π}{3} ) \frac{\int {B}_{C , j , L} ( {x}_{6} , {y}_{6} , {z}_{6} ) {dV}_{C , j , L}}{\int {dV}_{C , j , L}} ;$$
$${B}_{B , j , L \_ avg} = \frac{\int {B}_{B , j , L} ( {x}_{5} , {y}_{5} , {z}_{5} ) {dV}_{B , j , L}}{\int {dV}_{B , j , L}} + cos ( \frac{π}{3} ) \frac{\int {B}_{C , j , L} ( {x}_{6} , {y}_{6} , {z}_{6} ) {dV}_{C , j , L}}{\int {dV}_{C , j , L}} + cos ( \frac{2 π}{3} ) \frac{\int {B}_{A , j , L} ( {x}_{4} , {y}_{4} , {z}_{4} ) {dV}_{A , j , L}}{\int {dV}_{A , j , L}} ;$$
$${B}_{C , j , L \_ avg} = \frac{\int {B}_{C , j , L} ( {x}_{6} , {y}_{6} , {z}_{6} ) {dV}_{C , j , L}}{\int {dV}_{C , j , L}} + cos ( \frac{π}{3} ) \frac{\int {B}_{A , j , L} ( {x}_{4} , {y}_{4} , {z}_{4} ) {dV}_{A , j , L}}{\int {dV}_{A , j , L}} + cos ( \frac{2 π}{3} ) \frac{\int {B}_{B , j , L} ( {x}_{5} , {y}_{5} , {z}_{5} ) {dV}_{B , j , L}}{\int {dV}_{B , j , L}} ;$$
wherein B_{A,i,H_avg} is the average magnetic leakage intensity of the ith coil layer in the A-phase high-voltage coil, B_{A,i,H}(x₁,y₁,z₁) is magnetic leakage intensity of a coordinate point (x₁,y₁,z₁) of the ith coil layer in the A-phase high-voltage coil in the single-phase three-dimensional magnetic field model, dV_{A,i,H} is a micro-volume element of the ith coil layer in the A-phase high-voltage coil, B_{B,i,H}(x₂,y₂,z₂) is magnetic leakage intensity of a coordinate point (x₂,y₂,z₂) of the ith coil layer in the B-phase high-voltage coil in the single-phase three-dimensional magnetic field model, dV_{B,i,H} is a micro-volume element of the ith coil layer in the B-phase high-voltage coil, B_{C,i,H}(x₃,y₃,z₃) is magnetic leakage intensity of a coordinate point (x₃,y₃,z₃) of the ith coil layer in the C-phase high-voltage coil in the single-phase three-dimensional magnetic field model, dV_{C,i,H} is a micro-volume element of the ith coil layer in the C-phase high-voltage coil, B_{B,i,H_avg} is the average magnetic leakage intensity of the ith coil layer in the B-phase high-voltage coil, B_{C,i,H_avg} is the average magnetic leakage intensity of the ith coil layer in the C-phase high-voltage coil, B_{A,j,L_avg} is the average magnetic leakage intensity of the jth coil layer in the A-phase low-voltage coil, B_{A,j,L}(x₄,y₄,z₄) is magnetic leakage intensity of a coordinate point (x₄,y₄,z₄) of the jth coil layer in the A-phase low-voltage coil in the single-phase three-dimensional magnetic field model, dV_{A,j,L} is a micro-volume element of the jth coil layer in the A-phase low-voltage coil, B_{B,j,L}(x₅,y₅,z₅) is magnetic leakage intensity of a coordinate point (x₅,y₅,z₅) of the jth coil layer in the B-phase low-voltage coil in the single-phase three-dimensional magnetic field model, dV_{B,j,L} is a micro-volume element of the jth coil layer in the B-phase low-voltage coil, B_{C,j,L}(x₆,y₆,z₆) is magnetic leakage intensity of a coordinate point (x₆,y₆,z₆) of the jth coil layer in the C-phase low-voltage coil in the single-phase three-dimensional magnetic field model, dV_{C,j,L} is a micro-volume element of the jth coil layer in the C-phase low-voltage coil, B_{B,j,L_avg} is the average magnetic leakage intensity of the jth coil layer in the B-phase low-voltage coil, B_{C,j,L_avg} is the average magnetic leakage intensity of the jth coil layer in the C-phase low-voltage coil.

3. The method according to claim 2, wherein the respectively constructing an eddy current loss weight function of each coil layer in the coil according to the average magnetic leakage intensity of each coil layer in the coil comprises:
respectively constructing an eddy current loss weight function of each coil layer in the A-phase high-voltage coil, an eddy current loss weight function of each coil layer in the B-phase high-voltage coil and an eddy current loss weight function of each coil layer in the C-phase high-voltage coil by the following formulas:
$${W}_{A , i , H} = \frac{{B}_{A , i , H \_ avg}^{2}}{{\sum }_{i = 1}^{n} {B}_{A , i , H \_ avg}^{2}} , {W}_{B , i , H} = \frac{{B}_{B , i , H \_ avg}^{2}}{{\sum }_{i = 1}^{n} {B}_{B , i , H \_ avg}^{2}} , {W}_{C , i , H} = \frac{{B}_{C , i , H \_ avg}^{2}}{{\sum }_{i = 1}^{n} {B}_{C , i , H \_ avg}^{2}}$$
respectively constructing an eddy current loss weight function of each coil layer in the A-phase low-voltage coil, an eddy current loss weight function of each coil layer in the B-phase low-voltage coil and an eddy current loss weight function of each coil layer in the C-phase low-voltage coil by the following formulas:
$${W}_{A , j , L} = \frac{{B}_{A , j , L \_ avg}^{2}}{{\sum }_{j = 1}^{m} {B}_{A , j , L \_ avg}^{2}} , {W}_{B , j , L} = \frac{{B}_{B , j , L \_ avg}^{2}}{{\sum }_{j = 1}^{m} {B}_{B , j , L \_ avg}^{2}} , {W}_{C , j , L} = \frac{{B}_{C , j , L \_ avg}^{2}}{{\sum }_{j = 1}^{m} {B}_{C , j , L \_ avg}^{2}}$$
wherein W_{A,i,H} is the eddy current loss weight function of the ith coil layer in the A-phase high-voltage coil, n is the total number of the coil layer of the A-phase high-voltage coil, the B-phase high-voltage coil or the C-phase high-voltage coil, W_{B,i,H} is the eddy current loss weight function of the ith coil layer in the B-phase high-voltage coil, W_{A,j,L} is the eddy loss weight function of the ith coil layer in the C-phase high-voltage coil, W_{A,j,L} is the eddy current loss weight function of the jth coil layer in the A-phase low-voltage coil, m is the total number of the coil layer of the A-phase low-voltage coil, the B-phase low-voltage coil or the C-phase low-voltage coil, W_{B,j,L} is the eddy current loss weight function of the jth coil layer in the B-phase low-voltage coil, and W_{C,j,L} is the eddy current loss weight function of the jth coil layer in the C-phase low-voltage coil.

4. The method according to claim 3, wherein the respectively calculating eddy current loss of each coil layer in the coil according to a design calculation sheet of the target transformer and the eddy current loss weight function of each coil layer in the coil comprises:
respectively calculating eddy current loss of each coil layer in the A-phase high-voltage coil, eddy current loss of each coil layer in the B-phase high-voltage coil and eddy current loss of each coil layer in the C-phase high-voltage coil by the following formulas:
$${W}_{A , i , H \_ ecl} = \frac{{W}_{A , i , H} \times {W}_{H \_ list}}{3} , \\ {W}_{B , i , H \_ ecl} = \frac{{W}_{B , i , H} \times {W}_{H \_ list}}{3} , {W}_{C , i , H \_ ecl} = \frac{{W}_{C , i , H} \times {W}_{H \_ list}}{3}$$
respectively calculating eddy current loss of each coil layer in the A-phase low-voltage coil, eddy current loss of each coil layer in the B-phase low-voltage coil and eddy current loss of each coil layer in the C-phase low-voltage coil by the following formulas:
$${W}_{A , j , L \_ ecl} = \frac{{W}_{A , j , L} \times {W}_{L \_ list}}{3} , \\ {W}_{B , j , L \_ ecl} = \frac{{W}_{B , j , L} \times {W}_{L \_ list}}{3} , {W}_{C , j , L \_ ecl} = \frac{{W}_{C , j , L} \times {W}_{L \_ list}}{3}$$
wherein W_{A,i,H_ecl} is the eddy current loss of the ith coil layer in the A-phase high-voltage coil, W_{H_list} is eddy current loss under high voltage, on the design calculation sheet, of the target transformer, W_{B,i,H_ecl} is the eddy current loss of the ith coil layer in the B-phase high-voltage coil, W_{C,i,H_ecl} is the eddy current loss of the ith coil layer in the C-phase high-voltage coil, W_{A,j,L_ecl} is the eddy current loss of the jth coil layer in the A-phase low-voltage coil, W_{L_list} is eddy current loss under low voltage, on the design calculation sheet, of the target transformer, W_{B,j,L_ecl} is the eddy current loss of the jth coil layer in the B-phase low-voltage coil, and W_{C,j,L_ecl} is the eddy current loss of the jth coil layer in the C-phase low-voltage coil.

5. The method according to claim 2, further comprising:
judging whether the coil further comprises a medium-voltage coil or not, and the medium-voltage coil comprises an A-phase medium-voltage coil, a B-phase medium-voltage coil and a C-phase medium-voltage coil;
in the case that the coil further comprises the medium-voltage coil, respectively calculating average magnetic leakage intensity of each coil layer in a coil of the target transformer according to the single-phase three-dimensional magnetic field model further comprises:
respectively calculating average magnetic leakage intensity of each coil layer in the A-phase medium-voltage coil, average magnetic leakage intensity of each coil layer in the B-phase medium-voltage coil and average magnetic leakage intensity of each coil layer in the C-phase medium-voltage coil by the following formulas:
$${B}_{A , k , M \_ avg} = \frac{\int {B}_{A , k , M} ( {x}_{7} , {y}_{7} , {z}_{7} ) {dV}_{A , k , M}}{\int {dV}_{A , k , M}} + cos ( \frac{π}{3} ) \frac{\int {B}_{B , k , M} ( {x}_{8} , {y}_{8} , {z}_{8} ) {dV}_{B , k , M}}{\int {dV}_{B , k , M}} + cos ( \frac{2 π}{3} ) \frac{\int {B}_{C , k , M} ( {x}_{9} , {y}_{9} , {z}_{9} ) {dV}_{C , k , M}}{\int {dV}_{C , k , M}} ;$$
$${B}_{B , k , M \_ avg} = \frac{\int {B}_{B , k , M} ( {x}_{8} , {y}_{8} , {z}_{8} ) {dV}_{B , k , M}}{\int {dV}_{B , k , M}} + cos ( \frac{π}{3} ) \frac{\int {B}_{C , k , M} ( {x}_{9} , {y}_{9} , {z}_{9} ) {dV}_{C , k , M}}{\int {dV}_{C , k , M}} + cos ( \frac{2 π}{3} ) \frac{\int {B}_{A , k , M} ( {x}_{7} , {y}_{7} , {z}_{7} ) {dV}_{A , k , M}}{\int {dV}_{A , k , M}} ;$$
$${B}_{C , k , M \_ avg} = \frac{\int {B}_{C , k , M} ( {x}_{9} , {y}_{9} , {z}_{9} ) {dV}_{C , k , M}}{\int {dV}_{C , k , M}} + cos ( \frac{π}{3} ) \frac{\int {B}_{A , k , M} ( {x}_{7} , {y}_{7} , {z}_{7} ) {dV}_{A , k , M}}{\int {dV}_{A , k , M}} + cos ( \frac{2 π}{3} ) \frac{\int {B}_{B , k , M} ( {x}_{8} , {y}_{8} , {z}_{8} ) {dV}_{B , k , M}}{\int {dV}_{B , k , M}} ;$$
wherein B_{A,k,M_avg} is the average magnetic leakage intensity of the kth coil layer in the A-phase medium-voltage coil, B_{A,k,M}(x₇,y₇,z₇) is magnetic leakage intensity of a coordinate point (x₇,y₇,z₇) of the kth coil layer in the A-phase medium-voltage coil in coordinate point the single-phase three-dimensional magnetic field model, dV_{A,k,M} is a micro-volume element of the kth coil layer in the A-phase medium-voltage coil, B_{B,k,M}(x₈,y₈,z₈) is magnetic leakage intensity of a coordinate point (x₈,y₈,z₈) of the kth coil layer in the B-phase medium-voltage coil in the single-phase three-dimensional magnetic field model, dV_{B,k,M} is a micro-volume element of the kth coil layer in the B-phase medium-voltage coil, B_{C,k,M}(x₉,y₉,z₉) is magnetic leakage intensity of a coordinate point (x₉,y₉,z₉) of the kth coil layer in the C-phase medium-voltage coil in the single-phase three-dimensional magnetic field model, dV_{C,k,M} is a micro-volume element of the kth coil layer in the C-phase medium-voltage coil, B_{B,k,M_avg} is the average magnetic leakage intensity of the kth coil layer in the B-phase medium-voltage coil, and B_{C,k,M_avg} is the average magnetic leakage intensity of the kth coil layer in the C-phase medium-voltage coil.

6. The method according to claim 5, wherein the respectively constructing an eddy current loss weight function of each coil layer in the coil according to the average magnetic leakage intensity of each coil layer in the coil further comprises:
respectively constructing an eddy current loss weight function of each coil layer in the A-phase medium-voltage coil, an eddy current loss weight function of each coil layer in the B-phase medium-voltage coil and an eddy current loss weight function of each coil layer in the C-phase medium-voltage coil by the following formulas:
$${W}_{A , k , M} = \frac{{B}_{A , k , M \_ avg}^{2}}{{\sum }_{k = 1}^{P} {B}_{A , k , M \_ avg}^{2}} , {W}_{B , k , M} = \frac{{B}_{B , k , M \_ avg}^{2}}{{\sum }_{k = 1}^{P} {B}_{B , k , M \_ avg}^{2}} , {W}_{C , k , M} = \frac{{B}_{C , k , M \_ avg}^{2}}{{\sum }_{k = 1}^{P} {B}_{C , k , M \_ avg}^{2}}$$
wherein W_{A,k,M} is the eddy current loss weight function of the kth coil layer in the A-phase medium-voltage coil, p is the total number of the coil layer of the A-phase medium-voltage coil, the B-phase medium-voltage coil or the C-phase medium-voltage coil, W_{B,k,M} is the eddy current loss weight function of the kth coil layer in the B-phase medium-voltage coil, and W_{C,k,M} is the eddy current loss weight function of the kth coil layer in the C-phase medium-voltage coil.

7. The method according to claim 6, wherein the respectively calculating eddy current loss of each coil layer in the coil according to a design calculation sheet of the target transformer and the eddy current loss weight function of each coil layer in the coil further comprises:
respectively calculating eddy current loss of each coil layer in the A-phase medium-voltage coil, eddy current loss of each coil layer in the B-phase medium-voltage coil and eddy current loss of each coil layer in the C-phase medium-voltage coil by the following formulas:
$${W}_{A , k , M \_ ecl} = \frac{{W}_{A , k , M} \times {W}_{M \_ list}}{3} , \\ {W}_{B , k , M \_ ecl} = \frac{{W}_{B , k , M} \times {W}_{M \_ list}}{3} , {W}_{C , k , M \_ ecl} = \frac{{W}_{C , k , M} \times {W}_{M \_ list}}{3}$$
wherein W_{A,k,M_ecl} is the eddy current loss of the kth coil layer in the A-phase medium-voltage coil, W_{M_list} is eddy current loss under medium voltage, on the design calculation sheet, of the target transformer, W_{B,k,M_ecl} is the eddy current loss of the kth coil layer in the B-phase medium-voltage coil, and W_{C,k,M_ecl} is the eddy current loss of the kth coil layer in the C-phase medium-voltage coil.

8. The method according to claim 1, wherein the basic data comprises structural data of an iron core of the target transformer, structural data of an coil, structural data of a box, and rated current of the target transformer.

9. A computer-readable storage medium, having stored thereon a computer program, wherein when the computer program is executed by a processor, the processor implements the steps of the method according to claim 1.

10. A computer device, comprising a memory and a processor, the memory stores a computer program, and when the computer program is implemented by the processor, the processor implements the steps of the method according to claim 1.
